(19) United States
(12) Patent Application Publication
(10) Pub. No.: US 2022/0362787 A1
(43) Pub. Date: Nov. 17, 2022

(54) ROTARY ATOMIZATION TYPE PAINTING APPARATUS

(71) Applicant: HONDA MOTOR CO., LTD., Tokyo (JP)

(72) Inventors: Takashi Kikuchi, Tokyo (JP); Osamu Yashima, Tokyo (JP); Takumi Hasegawa, Tokyo (JP)

(21) Appl. No.: 17/739,270

(22) Filed: May 9, 2022

(30) Foreign Application Priority Data
May 17, 2021 (JP) 2021-083075

(51) Int. Cl. B05B 3/10

(52) U.S. Cl. CPC B05B 3/1014

(57) ABSTRACT

A rotary atomization type painting apparatus has a bell cup attached to a rotary drive shaft. A side surface of the bell cup is formed to be parallel to the rotary drive shaft. An inner surface of the side surface portion is provided with a first groove portion, a second groove portion, and a third groove portion that are recessed toward a direction of an outer surface of the side surface portion. The first groove portion, the second groove portion, and the third groove portion are provided with a first insertion hole, a second insertion hole, and a third insertion hole. The first insertion hole, the second insertion hole, and the third insertion hole pass through the inner surface and the outer surface, and eject a paint to the outside of the bell cup.

### CROSS-REFERENCE TO RELATED APPLICATION

Priority is claimed on Japanese Patent Application No. 2021-083075, filed May 17, 2021, the content of which is incorporated herein by reference.

### BACKGROUND OF THE INVENTION

### Field of the Invention

The present invention relates to a rotary atomization type painting apparatus.

### Description of Related Art

As a rotary atomization type painting apparatus, an apparatus in which a bell cup is provided on a rotary drive shaft, and the bell cup is rotated by the rotary drive shaft to eject (spray) paint from the bell cup to the outside is known. In the bell cup, for example, a peripheral wall (hereinafter referred to as a side surface portion) is formed in a cylindrical shape along a rotation axis of the bell cup, and a plurality of insertion holes inserted through an inner surface and an outer surface of the side surface portion are provided (for example, see Japanese Unexamined Patent Application, First Publication No. 2001-46927 (hereinafter referred to as Patent Document 1)).

According to the rotary atomization painting apparatus, when the bell cup rotates about a rotary drive shaft, the paint supplied to the inner surface of the side surface portion passes through a plurality of insertion holes, and is ejected to the outside of the side surface portion (that is, the outside of the bell cup). By causing the paint to pass through the plurality of insertion holes in this way, it is possible to limit the particle size of the paint ejected to the outside of the side surface portion not to be greater than the hole diameter of the insertion holes.

### SUMMARY OF THE INVENTION

However, in the rotary atomization type painting apparatus of Patent Document 1, when a supply amount of the paint supplied to the inner surface of the side surface portion is small, it is conceivable that the paint passing through the insertion hole be relatively insufficient with respect to the insertion hole, and the paint be ejected while the particle size of the paint is smaller than the hole size of the insertion hole.

In addition, in a range in which the particle size of the paint is smaller than the hole diameter of the insertion hole, because the particle size changes depending on the supply amount of the paint, it is difficult to stabilize the paint diameter. Therefore, in the rotary atomization type painting apparatus of Patent Document 1, there is a problem that the painting quality may not be stable.

Aspects of the present invention have been made in consideration of such circumstances, and an object of the present invention is to provide a rotary atomization type painting apparatus capable of stabilizing the particle size of the paint sprayed from the bell cup.

In order to solve the above problems and achieve the above object, the present invention has adopted the following aspects.

(1) A rotary atomization type painting apparatus according to an aspect of the present invention is a rotary atomization type painting apparatus in which a bell cup is attached to a rotary drive shaft of a painting apparatus, in which the bell cup has a side surface portion at least partially parallel to the rotary drive shaft, a groove portion recessed in a direction toward an outer surface of the side surface portion is provided on an inner surface of the side surface portion, and the groove portion is provided with an insertion hole configured to be inserted through the inner surface and the outer surface and eject a paint.

According to this configuration, the side surface portion is provided in the bell cup, and the groove portion is provided on the inner surface of the side surface portion. The groove portion is recessed toward the direction of the outer surface of the side surface portion. Therefore, the paint supplied to the side surface portion can be collected (accumulated) in the groove portion. The insertion hole is provided in the groove portion, and the insertion hole is inserted through the inner surface and the outer surface. Therefore, the paint collected in the groove can be ejected (sprayed) to the outside of the bell cup through the insertion hole.

This makes it possible to secure an ejection amount for paint which is ejected from the insertion hole by collecting the paint in the groove, even when the supply amount of paint supplied from the painting machine is small Therefore, the particle size of the paint ejected from the bell cup can be stabilized.

(2) In the aspect of above (1), the groove portion may be provided on the inner surface in an annular shape, and a plurality of the groove portions may be disposed on the side surface portion side by side in an axial direction of the rotary drive shaft.

According to this configuration, by providing the groove portion on the inner surface in an annular shape, the groove portion can be provided in a continuous linear shape (an arcuate line shape) along a circumferential direction of the inner surface. Therefore, in a state in which a plurality of groove portions are disposed on the side surface portion side by side in the rotary drive axis direction, the paint can be collected preferentially in the groove portion near a supply port of the paint.

As a result, when the supply amount of paint is small, the paint can be collected (stored) preferentially in the groove (a first row) on the paint supply port side. Therefore, even when the supply amount of the paint is small, the ejecting amount of the paint ejected from the insertion hole can be secured. As a result, the particle size of the paint ejected from the bell cup can be stabilized, and stable painting quality can be obtained.

By providing a plurality of grooves in the axial direction (a front-rear direction) on the side surface, paint can be collected in a plurality of grooves depending on the supply amount of paint.

As a result, when the supply amount of paint is large, the paint overflowing from the groove portion (the first row) on the supply port side of paint can be made to flow toward a next groove portion (a second row) by the centrifugal force of the rotating bell cup. Accordingly, even when the supply amount of the paint is large, or even when the supply amount of the paint changes and increases on the way, it is possible to prevent the paint from leaking from the bell cup other than through the insertion hole. Therefore, the particle size of the paint ejected from the bell cup can be stabilized, and stable painting quality can be obtained.

(3) In the aspect of above (2), the groove portion may have a plurality of insertion holes, and in the plurality of insertion holes, the insertion holes adjacent to each other in the axial direction may be disposed in a zigzag.

According to this configuration, among the plurality of insertion holes, insertion holes adjacent to each other in the axial direction of the rotary drive shaft are disposed in zigzag, by being displaced in the circumferential direction orthogonal to the axial direction of the rotary drive shaft. Therefore, it is possible to appropriately secure the interval between adjacent insertion holes and prevent the particles of the paint ejected from the adjacent insertion holes from interfering (colliding) with each other. As a result, the paint ejected from the adjacent insertion holes can be applied not to overlap, and more stable painting quality can be obtained.

By disposing adjacent insertion holes in zigzag, when the paint supplied to the groove portion is collected in the plurality of insertion holes, the region of the paint collected by one insertion hole can be prevented from overlapping the region of the paint collected by the adjacent insertion holes. As a result, the limited surface area of the bell cup can be effectively utilized without wasting the paint supplied to the bell cup.

(4) In the aspect of the above (1), a convex portion protruding from the inner surface toward the rotary drive shaft may be provided in a tip region in the axial direction of the rotary drive shaft in the side surface portion, and the convex portion may be provided on the inner surface in an annular shape.

According to this configuration, an annular convex portion (a dam portion) is provided in the tip region of the side surface portion (the bell cup). Therefore, even when the amount of paint supplied to the bell cup is large, it is possible to prevent the supplied paint from being ejected from the tip of the bell cup. As a result, the paint supplied to the bell cup is made to pass through only the plurality of insertion holes, and the paint can be ejected only from the plurality of insertion holes.

(5) In the aspect of the above (1), in the tip region of the side surface portion, a V-shaped notched portion extending in the axial direction of the rotary drive shaft may be provided on an inner surface portion of the tip region in the inner surface, and a plurality of the notched portions may be provided on the inner surface portion in an annular shape.

Here, when the amount of paint supplied to the bell cup is large, it is conceivable that the supplied paint be ejected from the tip of the bell cup. Therefore, in the tip region of the side surface portion, a notched portion is provided on the inner surface portion in an annular shape. Accordingly, when the paint is ejected from bell cup, the paint passes through the notched portion.

The notched portion through which the paint passes is formed in the V-shaped groove. As a result, the particle size of the paint ejected from the tip of the side surface portion can be stabilized by the notched portion, and stable painting quality can be obtained.

(6) In the aspect of above (5), in the tip region of the side surface portion, another V-shaped notched portion directed in a radial direction of the rotary drive shaft may be provided at the tip in the axial direction of the rotary drive shaft, and a plurality of other notched portions may be provided at the tip in an annular shape.

According to this configuration, in the tip region of the side surface portion, the other notched portion is provided at the tip in an annular shape. Therefore, when a large amount of paint is supplied to the bell cup and the paint is ejected from the tip portion of the bell cup, the paint passes through the other notched portion.

The notched portion through which the paint passes is formed in a V-shaped groove. As a result, the particle size of the paint ejected from the tip of the side surface portion can be stabilized with the notched portion, and stable painting quality can be obtained.

According to the aspect of the present invention, the paint is collected in the groove portion and ejected through the insertion hole. As a result, the particle size of the paint sprayed from the bell cup can be stabilized even when the supply amount of the paint is small.

### BRIEF DESCRIPTION OF THE DRAWINGS

FIG. 1 is a perspective view showing an example of painting a vehicle body with a rotary atomization type painting apparatus according to a first embodiment of the present invention.

FIG. 2 is a cross-sectional view showing a bell cup provided in the rotary atomization type painting apparatus of the first embodiment.

FIG. 3 is a perspective view showing a side surface portion provided in the bell cup of FIG. 2 in a state of being cut away in an axial direction.

FIG. 4 is an enlarged cross-sectional view showing a portion IV of FIG. 2.

FIG. 5 is a developed view showing a first insertion hole provided in a first groove portion of the bell cup of the first embodiment.

FIG. 6 illustrates as follows: FIG. 6(a) is a cross-sectional view showing an example in which paint is collected in a first groove portion of the bell cup and ejected from a first insertion hole; FIG. 6(b) is a cross-sectional view showing an example in which paint is collected in a second groove portion of the bell cup and ejected from a second insertion hole; FIG. 6(c) is a cross-sectional view showing an example in which paint is collected in a third groove portion of the bell cup and ejected from a third insertion hole; and FIG. 6(d) is a cross-sectional view showing an example of stopping paint at a convex portion of the bell cup.

FIG. 7 is a developed view showing a first insertion hole of a comparative example.

FIG. 8 illustrates as follows: FIG. 8(a) is a cross-sectional view showing a side surface portion of a first modified example of the first embodiment; FIG. 8(b) is a cross-sectional view showing a side surface portion of a second modified example of the first embodiment; and FIG. 8(c) is a cross-sectional view showing a side surface portion of a third modified example of the first embodiment.

FIG. 9 illustrates as follows: FIG. 9(a) is a developed view showing the first insertion hole to the third insertion hole of a fourth modified example of the first embodiment; FIG. 9(b) is a developed view showing the first insertion hole to the third insertion hole of a fifth modified example of the first embodiment; and FIG. 9(c) is a developed view showing the first insertion hole to the third insertion hole of a sixth modified example of the first embodiment.

FIG. 10 is a cross-sectional view showing a side surface portion of a seventh modified example of the first embodiment.

FIG. 11 is a cross-sectional view showing a side surface portion of a second embodiment according to the present invention.

FIG. 12 is a cross-sectional view showing a side surface portion of a third embodiment according to the present invention.

FIG. 13 is a front view of the side surface portion of the third embodiment as viewed from a tip side.

FIG. 14 is a cross-sectional view showing a bell cup according to a fourth embodiment of the present invention.

### DETAILED DESCRIPTION OF THE INVENTION

Hereinafter, an embodiment of the present invention will be described with reference to the rotary atomization type painting apparatus on the basis of the drawings.

### First Embodiment

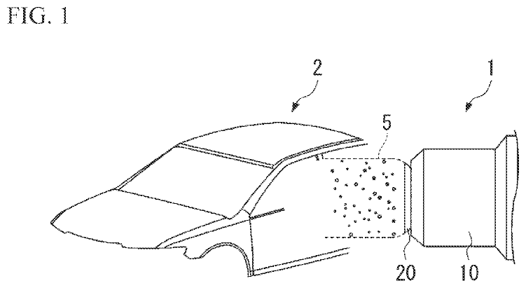

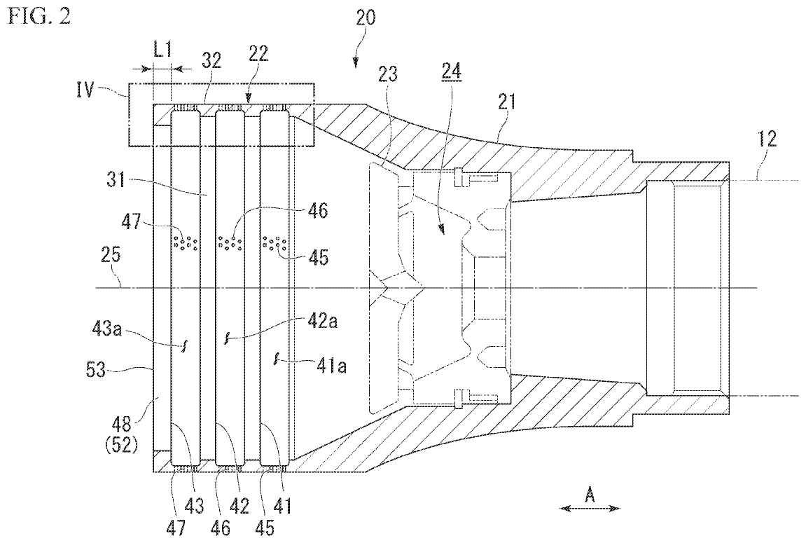

As shown in FIGS. 1 and 2, a rotary atomization type painting apparatus 1 electrostatically paints a body 2 of a vehicle, which is an object to be painted, with a mist-like paint. The rotary atomization type painting apparatus 1 includes an apparatus main body 10, a rotary drive shaft 12 rotatably provided on the apparatus main body 10, and a bell cup (rotary atomization head) 20 attached to a tip portion of the rotary drive shaft 12. Hereinafter, the rotary atomization type painting apparatus 1 may be abbreviated as “painting apparatus 1”.

The rotary drive shaft 12 is rotatably supported on, for example, the apparatus main body 10 by a motor. The bell cup 20 is rotatably supported by the rotary drive shaft 12, for example, in a state in which a voltage for electrostatic painting is applied. The paint 5 radially ejected (sprayed) from the bell cup 20 by a centrifugal force due to the rotation of the bell cup 20 is charged and applied to be attracted to the body 2 of the vehicle.

As shown in FIGS. 2 to 4, the bell cup 20 has a bell cup main body 21 and a side surface portion 22. The bell cup main body 21 is provided on the rotary drive shaft 12 in a state of being disposed coaxially with respect to a direction of an axis 25 on the rotary drive shaft 12 (that is, a direction of an arrow A). A closing portion 23 is coaxially housed in the bell cup main body 21. The closing portion 23 is provided on the rotary drive shaft 12. A space 24 of the closing portion 23 is an atomizing chamber for applying the centrifugal force to the paint.

Hereinafter, the direction of the axis 25 on the rotary drive shaft 12 may be referred to as an “axial direction of the rotary drive shaft 12” or simply an “axial direction”.

The side surface portion 22 is integrally formed with the bell cup main body 21 in a state of being disposed coaxially with the axis 25 of the rotary drive shaft 12. Specifically, the side surface portion 22 is a peripheral wall portion that extends from the tip portion of the bell cup main body 21 toward a side away from the rotary drive shaft 12 in the axial direction and is formed in a cylindrical shape parallel to the axial direction.

Since the side surface portion 22 is formed in a cylindrical shape, the inner surface 31 and the outer surface 32 are formed on a circumferential surface. The side surface portion 22 has, for example, groove portions 41, 42, and 43, insertion holes 45, 46, and 47, and a convex portion 48. The groove portions 41, 42, and 43 include, for example, a first groove portion 41, a second groove portion 42, and a third groove portion 43.

In the embodiment, although three groove portions (that is, the first groove portion 41, the second groove portion 42, and the third groove portion 43) will be described as an example, the number of groove portions can be arbitrarily selected.

The first groove portion 41 is provided at a first position on the inner surface 31 of the side surface portion 22 closest to the bell cup main body 21. The first groove portion 41 is formed in an annular shape to be recessed toward the direction of the outer surface 32 of the side surface portion 22 at the first position of the inner surface 31. Therefore, the first groove portion 41 is provided, for example, in a continuous linear shape (an arcuate line shape) along the circumferential direction of the inner surface 31.

The second groove portion 42 is provided at a second position on the inner surface 31 of the side surface portion 22 further away from the bell cup main body 21 than the first position. The second groove portion 42 is formed in an annular shape to be recessed toward the direction of the outer surface 32 of the side surface portion 22 at the second position of the inner surface 31. Therefore, the second groove portion 42 is provided in a continuous linear shape (an arcuate line shape) along the circumferential direction of the inner surface 31, for example, like the first groove portion 41.

The third groove portion 43 is provided at a third position of the inner surface 31 of the side surface portion 22 away from the bell cup main body 21 farther than the second position. The third groove portion 43 is formed in an annular shape to be recessed toward the direction of the outer surface 32 of the side surface portion 22 at the third position of the inner surface 31. Therefore, the third groove portion 43 is provided in a continuous linear shape (an arcuate line shape) along the circumferential direction of the inner surface 31, for example, like the first groove portion 41 and the second groove portion 42.

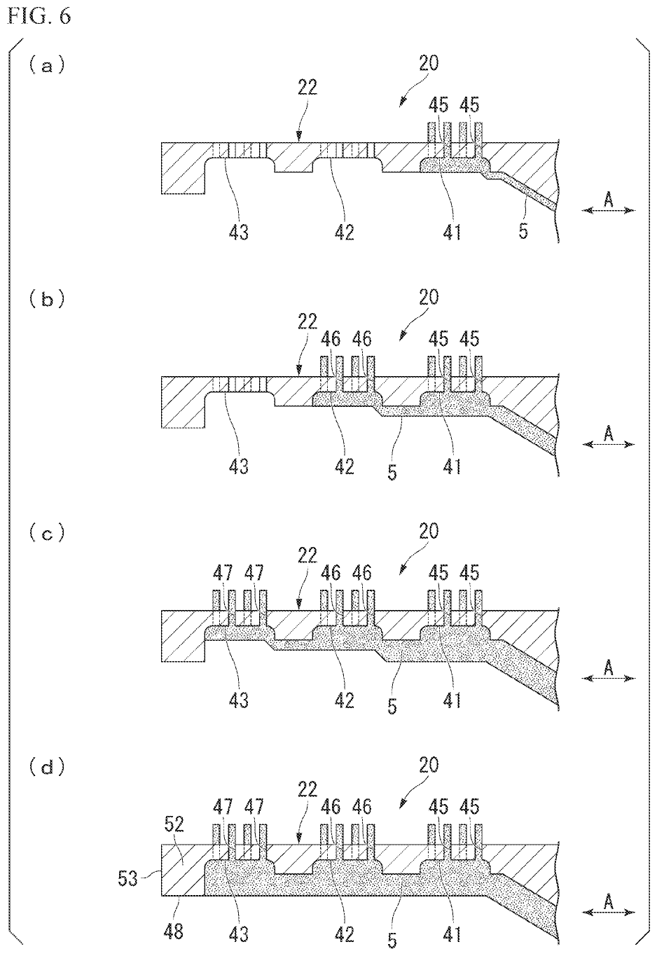

That is, each of the first groove portion 41, the second groove portion 42, and the third groove portion 43 are provided side by side on the side surface portion 22 at intervals in the axial direction (a front-rear direction) of the rotary drive shaft 12. As a result, the paint 5 (see FIGS. 6(a) to 6(d)) can be collected preferentially in the groove portion near a paint supply port (not shown). That is, the paint 5 supplied to the side surface portion 22 can be collected in the order of the first groove portion 41 in the first row, the second groove portion 42 in the second row, and the third groove portion 43 in the third row from the paint supply port.

By providing a plurality of the first groove portions 41, the second groove portions 42, and the third groove portion 43 side by side in the axial direction, the paint 5 can be collected to the first groove portion 41, the second groove portion 42, and the third groove portion 43 depending on the supply amount of the paint 5.

In the first embodiment, although an example in which the linear shape of the first groove portion 41, the second groove portion 42, and the third groove portion 43 is formed into an arcuate shape will be described, the present invention is not limited thereto. As another example, for example, the linear shape of the first groove portion 41, the second groove portion 42, and the third groove portion 43 may be selected from various shapes such as a wavy shape and a zigzag shape.

The first groove portion 41 has a plurality of first insertion holes 45 as insertion holes. The first insertion holes 45 are inserted from a first groove inner surface (a bottom surface) 41a of the first groove portion 41 of the inner surface 31 to the outer surface 32, and are formed as, for example, a round hole. The first insertion hole 45 ejects the paint 5 supplied to the first groove portion 41 to the outside of the side surface portion 22 (that is, the bell cup 20).

The second groove portion 42 has a plurality of second insertion holes 46 as insertion holes. The second insertion hole 46 is inserted from a second groove inner surface (a bottom surface) 42a of the second groove portion 42 of the inner surface 31 to the outer surface 32, and is formed of, for example, a round hole. The second insertion hole 46 ejects the paint 5 supplied to the second groove portion 42 to the outside of the side surface portion 22 (that is, the bell cup 20).

The third groove portion 43 has a plurality of third insertion holes 47 as insertion holes. The third insertion hole 47 is inserted from a third groove inner surface (a bottom surface) 43a of the third groove portion 43 of the inner surface 31 to the outer surface 32, and is formed of, for example, a round hole. The third insertion hole 47 ejects the paint 5 supplied to the third groove portion 43 to the outside of the side surface portion 22 (that is, the bell cup 20).

As shown in FIG. 5, the plurality of first insertion holes 45 are disposed in a zigzag shape such that the first insertion holes 45 adjacent to each other in the axial direction (that is, the direction of the arrow A) are displaced in the circumferential direction orthogonal to the axial direction. That is, the plurality of first insertion holes 45 are disposed in a zigzag shape on the first groove inner surface 41a. Hereinafter, the zigzag-shaped arrangement may be referred to as a “zigzag shape”.

The plurality of second insertion holes 46 and the plurality of third insertion holes 47 are also disposed in a zigzag shape in the same manner as the plurality of first insertion holes 45. The reason why the plurality of first insertion holes 45, the plurality of second insertion holes 46, and the plurality of third insertion holes 47 are disposed in a zigzag shape will be described below in detail.

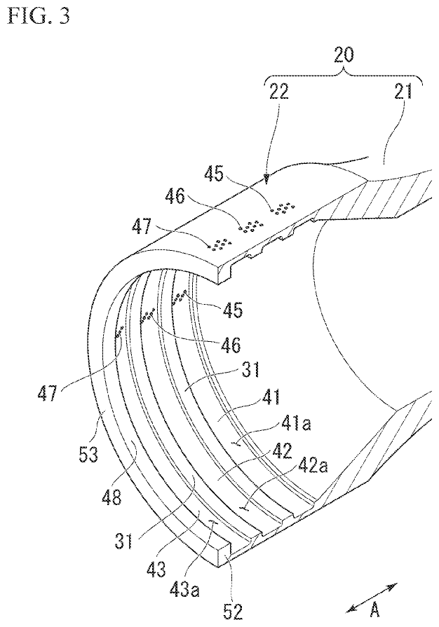

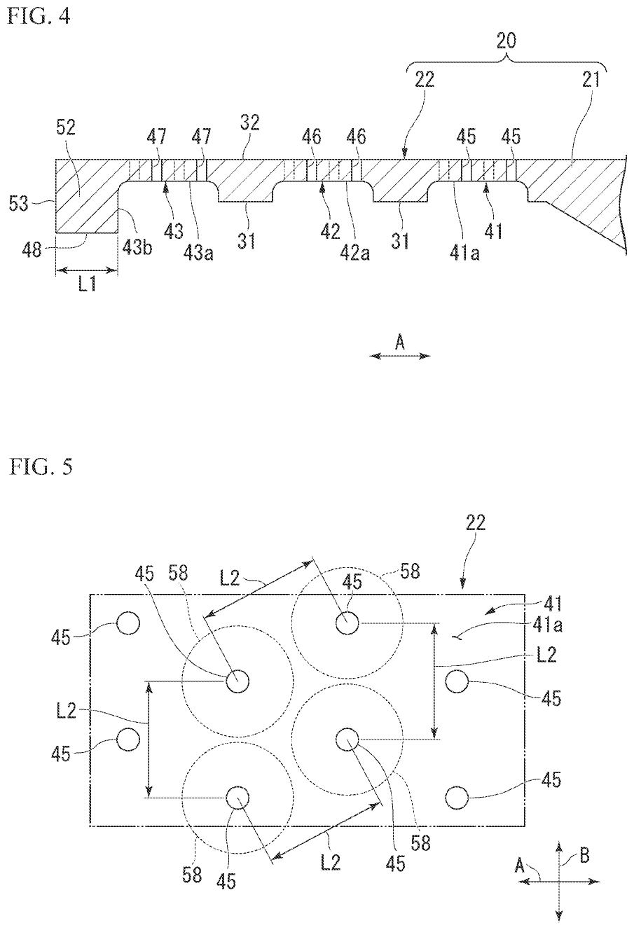

Returning to FIGS. 3 and 4, a convex portion (a dam portion) 48 is provided in a tip region 52 in the axial direction of the rotary drive shaft 12 in the side surface portion 22. The tip region 52 is a region up to a position 54 separated from the tip 53 of the side surface portion 22 by a predetermined range L1 on the side of the third groove portion 43 in the axial direction.

The convex portion 48 is formed to protrude from the inner surface 31 toward the axis 25 (see FIG. 2) of the rotary drive shaft 12 in the tip region 52, and is provided in an annular shape along the inner surface 31. As an example in the embodiment, the convex portion 48 forms a groove wall 43b on the tip 53 side of the third groove portion 43.

Next, an example of ejecting the paint 5 with the painting apparatus 1 of the first embodiment will be described on the basis of FIGS. 6(a) to 6(d).

As shown in FIG. 6(a), when the supply amount of the paint 5 supplied to the side surface portion 22 is small, the paint can be collected (accumulated) preferentially in the first groove portion 41 closest to the supply port side of paint. Therefore, even when the supply amount of the paint 5 is small, the ejecting amount of the paint 5 ejected from the plurality of first insertion holes 45 can be secured, by collecting the paint 5 in the first groove portion 41. As a result, the particle size of the paint 5 ejected from the side surface portion 22 (that is, the bell cup 20) can be stabilized, and stable painting quality can be obtained.

As shown in FIG. 6(b), when the supply amount of the paint 5 supplied to the side surface portion 22 is large, the paint 5 overflowing from the first groove portion 41 is made to flow toward the second groove portion 42 by the centrifugal force of the rotating bell cup 20, and can also be collected in the second groove portion 42. Therefore, it is possible to secure the ejecting amount of the paint 5 ejected from the plurality of second insertion holes 46.

As a result, even if the supply amount of the paint 5 is large, or even if the supply amount of the paint 5 changes and increases on the way, it is possible to prevent the paint 5 from leaking from the bell cup 20 other than the plurality of first insertion holes 45 and the plurality of second insertion holes 46. Therefore, the particle size of the paint 5 ejected from the side surface portion 22 (that is, the bell cup 20) can be stabilized, and stable painting quality can be obtained.

As shown in FIG. 6(c), when the supply amount of the paint 5 supplied to the side surface portion 22 is further increased, the paint 5 overflowing from the second groove portion 42 is made to flow toward the third groove portion 43 by the centrifugal force of the rotating bell cup 20, and can also be collected in the third groove portion 43. Therefore, it is possible to secure the ejecting amount of the paint 5 ejected from the plurality of third insertion holes 47.

As a result, even when the supply amount of the paint 5 further increases and the paint 5 overflows from the second groove portion 42, it is possible to prevent the paint 5 from leaking from the bell cup 20 other than the plurality of first insertion holes 45, the plurality of second insertion holes 46, and the plurality of third insertion holes 47. Therefore, the particle size of the paint 5 ejected from the side surface portion 22 (that is, the bell cup 20) can be stabilized, and stable painting quality can be obtained.

As shown in FIG. 6(d), an annular convex portion 48 is provided in the tip region 52 of the side surface portion 22. The convex portion 48 can serve as a dam for stopping the supplied paint 5, even when the supply amount of the paint 5 supplied to the side surface portion 22 is further increased. Therefore, it is possible to prevent the supplied paint 5 from being ejected from the tip 53 beyond the convex portion 48.

As a result, the paint 5 supplied to the side surface portion 22 is made to pass through only the plurality of first insertion holes 45, the plurality of second insertion holes 46, and the plurality of third insertion holes 47, and the paint 5 can be ejected only from the respective insertion holes 45, 46, and 47.

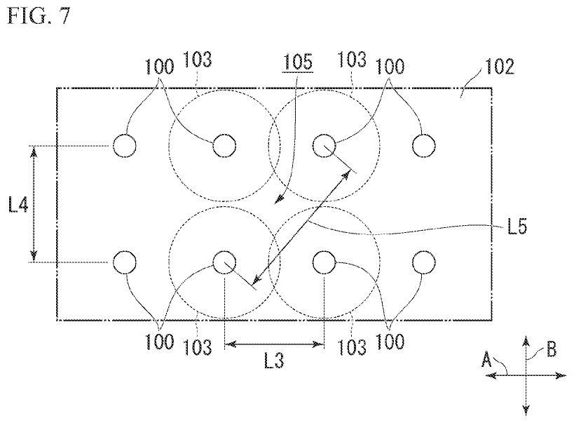

Next, the reasons for disposing the plurality of first insertion holes 45, the plurality of second insertion holes 46, and the plurality of third insertion holes 47 in a zigzag shape will be described on the basis of FIGS. 4, 5, and 7. FIG. 5 shows a first embodiment in which a plurality of first insertion holes 45 are disposed in a zigzag shape. FIG. 7 shows a comparative example in which a plurality of first insertion holes 100 are disposed in a grid shape in the axial direction (the direction of arrow A) and the circumferential direction (the direction of arrow B).

As shown in FIGS. 4 and 5, the plurality of first insertion holes 45 of the embodiment are provided in the first groove portion 41 in a zigzag shape. Therefore, the plurality of first insertion holes 45, for example, the adjacent first insertion holes 45 can be kept at the same interval L2, and the interval L2 can be appropriately secured. As a result, it is possible to prevent the particles of the paint 5 (see FIG. 6(a)) ejected from the adjacent first insertion hole 45 to the outside of the side surface portion 22 from interfering (colliding) with each other. Therefore, the paint 5 ejected from the adjacent first insertion hole 45 can be applied not to overlap, and more stable painting quality can be obtained.

Further, by disposing the adjacent first insertion holes 45 in a zigzag shape, the paint can be efficiently collected in each of the first insertion holes 45. That is, when the paint 5 supplied to the first groove portion 41 is collected in the plurality of first insertion holes 45, it is possible to prevent the region 58 of the paint 5 collected by each of the first insertion hole 45 from overlapping the region 58 of the paint 5 collected by the adjacent first insertion hole 45.

Therefore, on the inner surface (surface) 31 of the side surface portion 22 to which the paint 5 is supplied, it is possible to reduce at least the overlapping region or the area outside the region with respect to the contrast structure. As a result, the limited surface area of the side surface portion 22 (that is, the bell cup 20) can be effectively utilized, without wasting the paint 5 supplied to the side surface portion 22.

By the way, as shown in FIG. 7, the plurality of first insertion holes 100 of the comparative example are provided in the first groove portion 102 in a grid shape. Therefore, in the plurality of first insertion holes 100, for example, it is considered that the first interval L3 and the second interval L4 and the third interval L5 between the adjacent first insertion holes 100 are different in the axial direction (direction of arrow A), the circumferential direction (direction of arrow B), and the diagonal line.

The first interval L3 is an interval between the first insertion holes 100 adjacent to each other in the axial direction (direction of arrow A). The second interval L4 is an interval between the first insertion holes 100 adjacent to each other in the circumferential direction (direction of arrow B). The third interval L5 is an interval between the first insertion holes 100 adjacent to each other on the diagonal line.

Here, in the first interval L3, the second interval L4, and the third interval L5, for example, it is considered that the second interval L4 is greater than the first interval L3 and the third interval L5 is greater than the second interval L4.

In this case, for example, when the second interval L4 is set so that the particles of the paint ejected from the adjacent first insertion holes 100 in the circumferential direction do not interfere (collide) with each other, paint particles ejected from the adjacent first insertion hole 100 set at the first interval L3 in the axial direction interfere with each other. Further, a space is generated between the paints 5 ejected from the adjacent first insertion hole 100 set at the third interval L5 on the diagonal line. Therefore, it is difficult to obtain stable painting quality due to the paint ejected from the adjacent first insertion hole 100.

Further, by disposing the plurality of first insertion holes 100 in a grid shape, it is difficult to efficiently collect the paint in each of the first insertion holes 100. For example, by setting the first insertion holes 100 adjacent to each other in the circumferential direction at the second interval L4, it is possible to prevent the region 103 of the paint collected by one of the first insertion holes 100 from overlapping the region 103 of the paint collected by the other first insertion hole 100.

However, for example, by setting the first insertion holes 100 adjacent to each other in the axial direction at the first interval L3, the region 103 of the paint collected by one of the first insertion holes 100 overlaps the region 103 of the paint collected by the other first insertion hole 100. Further, for example, by setting the adjacent first insertion holes 100 on the diagonal line at the third interval L5, an interval (gap) 105 is generated in the region 103 of the paint collected by one of the first insertion holes 100 with respect to the region 103 of the paint collected by the other first insertion hole 100.

Therefore, it is difficult to efficiently collect the paint of the first groove portion with the plurality of first insertion holes 100.

The plurality of second insertion holes 46 and the plurality of third insertion holes 47 shown in FIG. 4 are also disposed in the second groove portion 42 and the third groove portion 43 in a zigzag shape, in the same manner as the plurality of first insertion holes 45. As a result, the paint 5 (see FIG. 6(b)) ejected from the plurality of second insertion holes 46 can be applied not to overlap. Further, when the paint is collected in the plurality of second insertion holes 46, the region of the paint 5 collected by each second insertion hole 46 can be prevented from overlapping the region of the paint 5 collected by the adjacent second insertion holes 46.

The paint 5 (see FIG. 6(c)) sprayed (ejected) from the plurality of third insertion holes 47 can be applied not to overlap. When collecting the paint in a plurality of third insertion holes 47, the region of the paint 5 collected by each third insertion hole 47 can be prevented from overlapping the region of the paint 5 collected by the adjacent third insertion holes 47.

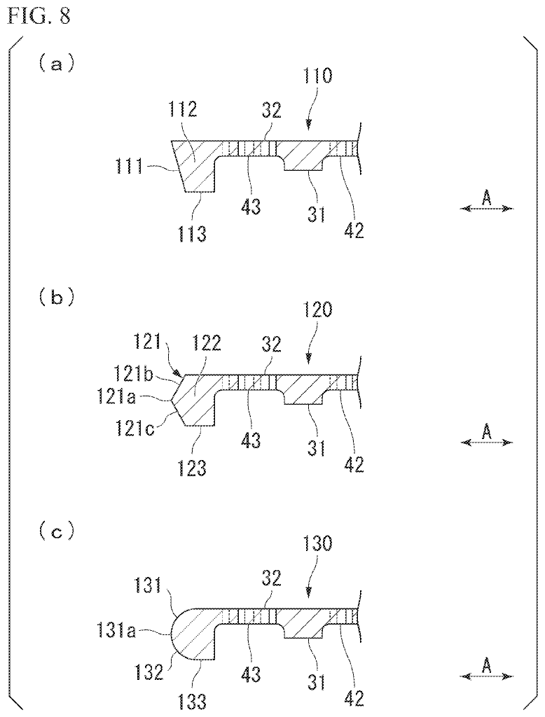

Next, modified examples 1 to 7 of the side surface portion 22 in the first embodiment will be described on the basis of FIGS. 8(a) to 8(c), FIGS. 9(a) to 9(c), and FIG. 10. In the modified examples 1 to 7, the same and similar configurations as the side surface portion 22 of the first embodiment are denoted by the same reference numerals, and detailed description thereof will be omitted.

### Modified Example 1

As shown in FIG. 8(a), a side surface portion 110 has a tip 111 formed in an inclined shape. That is, the tip 111 of the side surface portion 110 extends in an inclined shape toward a third groove portion 43 in the axial direction from an outer surface 32 of the side surface portion 110 toward an inner surface (inner peripheral surface) 113 of a convex portion 112.

Also in the side surface portion 110 of the modified example 1, as in the side surface portion 22 of the first embodiment, even when the supply amount of the paint 5 (see FIG. 6(d)) supplied to the side surface portion 110 increases, the supplied paint 5 can be stopped with the convex portion 112.

### Modified Example 2

As shown in FIG. 8(b), a side surface portion 120 has a tip 121 formed in a V-shaped cross section. That is, in the tip 121 of the side surface portion 120, a center 121a between an outer surface 32 of a side surface portion 120 and an inner surface (inner peripheral surface) 123 of a convex portion 122 protrudes to the opposite side of the third groove portion 43 in the radial direction of the side surface portion 120. As a result, the tip 121 is formed in a V-shaped cross section by the first inclined surface 121b and the second inclined surface 121c.

Also in the side surface portion 120 of the modified example 2, as in the side surface portion 22 of the first embodiment, even when the supply amount of the paint 5 (see FIG. 6(d)) supplied to the side surface portion 120 increases, the supplied paint 5 can be stopped at the convex portion 122.

### Modified Example 3

As shown in FIG. 8(c), a side surface portion 130 has a tip 131 formed in a curved cross section. That is, in the tip 131 of the side surface portion 130, a center 131a between an outer surface 32 of a side surface portion 130 and an inner surface (inner peripheral surface) 133 of a convex portion 132 protrudes to the opposite side of the third groove portion 43 in a curved shape in the radial direction of the side surface portion 130.

Also in the side surface portion 130 of the modified example 3, as in the side surface portion 22 of the first embodiment, even when the supply amount of the paint 5 (see FIG. 6(d)) supplied to the side surface portion 130 increases, the supplied paint 5 can be stopped at the convex portion 132.

### Modified Example 4

As shown in FIG. 9(a), the first insertion hole 45, the second insertion hole 46, and the third insertion hole 47 of the first embodiment may be changed from a round hole to a first insertion hole 141, a second insertion hole 142 and a third insertion hole 143 of an elliptical hole or an elongated hole. Even if the first insertion hole 141, the second insertion hole 142, and the third insertion hole 143 are changed to an elliptical hole or an elongated hole, the same effect as that of the first embodiment can be obtained.

### Modified Example 5

As shown in FIG. 9(b), the first insertion hole 45, the second insertion hole 46, and the third insertion hole 47 of the first embodiment may be changed from the round hole to a first insertion hole 151, a second insertion hole 152, and a third insertion hole 153 of a slit. Even if the first insertion hole 151, the second insertion hole 152, and the third insertion hole 153 are changed to the slit, the same effect as that of the first embodiment can be obtained.

### Modified Example 6

As shown in FIG. 9(c), the first insertion hole 45, the second insertion hole 46, and the third insertion hole 47 of the first embodiment may be changed from the round hole to a first insertion hole 161, a second insertion hole 162 and a third insertion hole 163 of a cross-shaped hole. Even if the first insertion hole 161, the second insertion hole 162, and the third insertion hole 163 are changed to a cross-shaped hole, the same effect as that of the first embodiment can be obtained.

### Modified Example 7

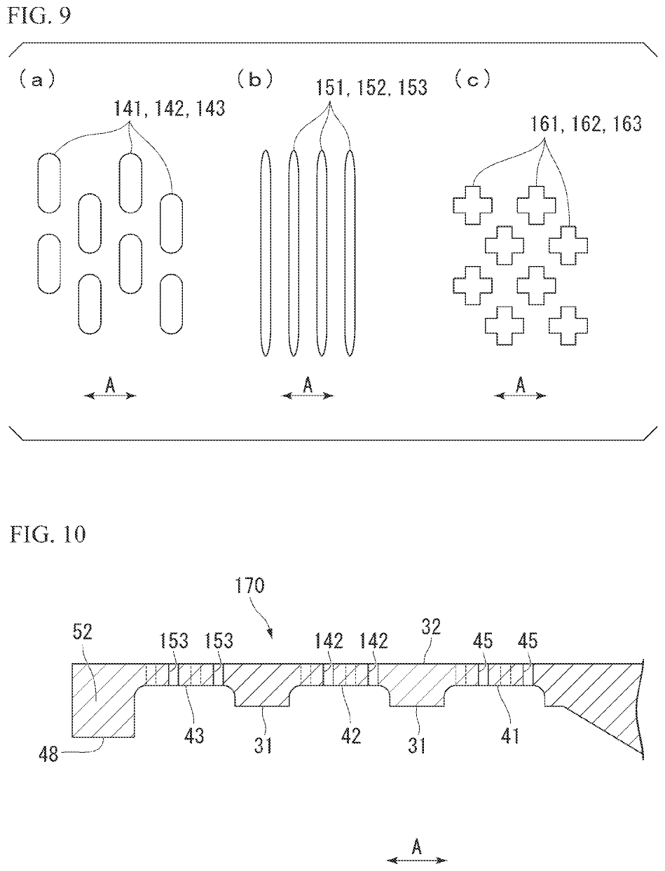

As shown in FIG. 10, in a side surface portion 170, for example, the first insertion hole 45 of a round hole may be formed in the first groove portion 41, the second insertion hole 142 of an ellipse or an elongated hole may be formed in the second groove portion 42, and the third insertion hole 153 of the slit may be formed in the third groove portion 43. The same effect as that of the side surface portion 22 of the first embodiment can be obtained in the side surface portion 170 of the modified example 7.

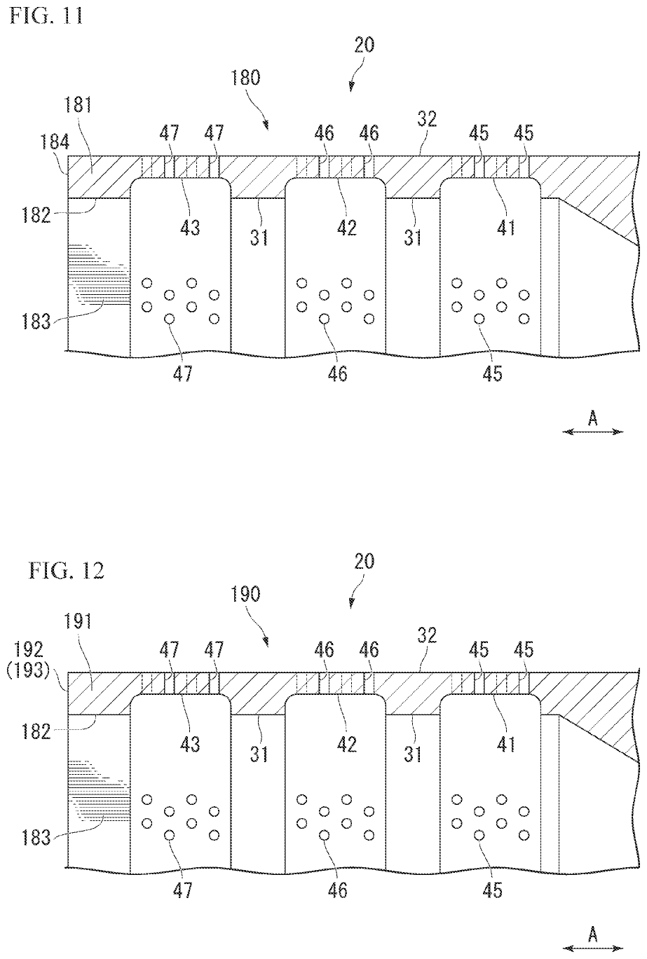

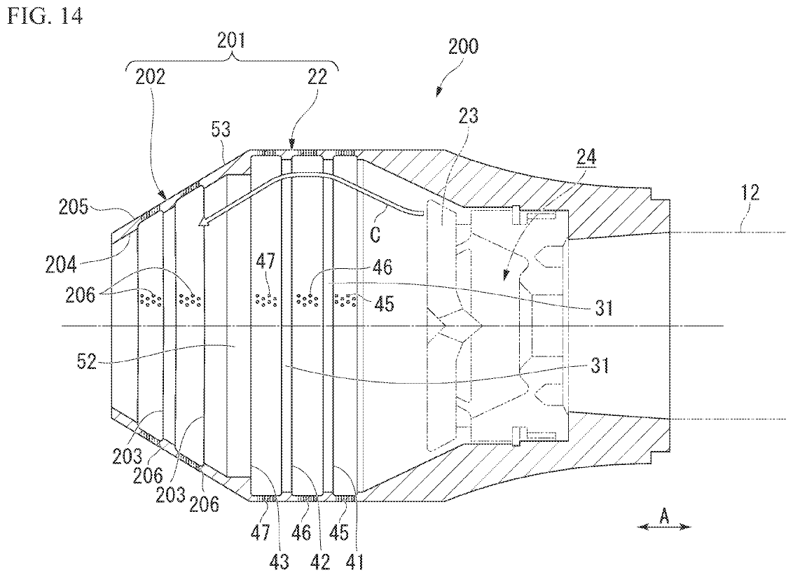

Next, the side surface portions of the second embodiment and the third embodiment will be described on the basis of FIGS. 11 to 13, and the bell cup of the fourth embodiment will be described on the basis of FIG. 14. In the second to fourth embodiments, the same and similar configurations as the side surface portion 22 and the bell cup 20 of the first embodiment are denoted by the same reference numerals, and detailed description thereof will be omitted.

### Second Embodiment

As shown in FIG. 11, a side surface portion 180 has a notched portion 183 provided on an inner peripheral surface 182 of a tip region 181 (an inner surface portion of the tip region 181 of the inner surface 31). The inner peripheral surface 182 of the tip region 181 is formed in a circular shape to be flush with the inner surface 31 of the side surface portion 180. The notched portion 183 extends in the axial direction (that is, the direction of arrow A) on the inner peripheral surface 182.

The notched portion 183 is formed in a groove having a V-shaped cross section so that a notched width gradually decreases from the inner peripheral surface 182 toward the outer surface 32. Because a plurality of notched portions 183 are continuously provided on the inner peripheral surface 182 at minute intervals in the circumferential direction of the side surface portion 180, the notched portions 183 are provided in an annular shape along the inner peripheral surface 182.

The reason why the plurality of notched portions 183 are provided in an annular shape on the inner peripheral surface 182 of the tip region 181 is as follows. That is, when the supply amount of the paint 5 (see FIG. 6(c)) supplied to the side surface portion 180 (the bell cup 20) is large, it is considered that the supplied paint is ejected from the tip 184 of the side surface portion 180.

Therefore, in the tip region 181 of the side surface portion 180, a plurality of notched portions 183 are provided on the inner peripheral surface 182 in an annular shape in the circumferential direction. Accordingly, when the paint is ejected from the tip 184 of the side surface portion 180, the paint 5 passes through the plurality of notched portions 183. The plurality of notched portions 183 through which the paint 5 passes are formed in the V-shaped grooves. As a result, the particle size of the paint 5 ejected from the tip 184 of the side surface portion 180 can be stabilized by the plurality of notched portions 183, and stable painting quality can be obtained.

### Third Embodiment

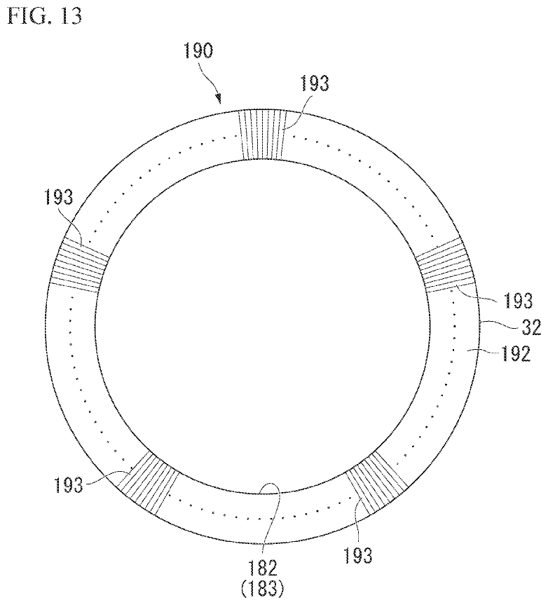

As shown in FIGS. 12 and 13, a side surface portion 190 has a tip notched portion (other notched portion) 193 provided on the side surface portion 180 of the second embodiment, and other configurations are the same as those of the side surface portion 180 of the second embodiment.

The tip notched portion 193 is provided at the tip 192 of the tip region 191 of the side surface portion 190. The tip 192 of the tip region 191 is formed on an annular flat surface along the radial direction of the rotary drive shaft 12 (see FIG. 2). The plurality of tip notched portions 193 extend in the radial direction of the rotary drive shaft 12 at the tip 192 of the tip region 191.

The tip notched portion 193 is formed in a groove having a V-shaped cross section so that a notched width gradually decreases from the tip 192 toward the third groove portion 43 in the axial direction. Because a plurality of tip notched portions 193 are continuously provided at the tip 192, for example, at minute intervals in the circumferential direction of the side surface portion 190, the tip notched portions 193 are provided in an annular shape along the tip 192.

Therefore, when a large amount of the paint 5 (see FIG. 6(c)) is supplied to the side surface portion 190 (the bell cup 20) and the paint 5 is ejected from the tip 192 of the side surface portion 190, the paint 5 passes through the plurality of notched portions 183, and then, passes through a plurality of tip notched portions 193.

The tip notched portion 193 through which the paint 5 passes is formed in a V-shaped groove. As a result, the particle size of the paint 5 ejected from the tip 192 of the side surface portion 190 can be stabilized by the tip notched portion 193, and stable painting quality can be obtained.

### Fourth Embodiment

As shown in FIG. 14, a bell cup 200 has a side surface portion 201 instead of the side surface portion 22 in the bell cup 20 of the first embodiment, and the other configurations are the same as those of the bell cup 20 of the first embodiment. The side surface portion 201 has a side surface portion 22 of the first embodiment, and an inclined side surface portion 202. In the side surface portion 201, the tip region 52 of the side surface portion 22 of the first embodiment is formed to be flush with the inner surface 31.

The inclined side surface portion 202 is integrally provided at the tip 53 of the side surface portion 22. Specifically, the inclined side surface portion 202 is formed in a cylindrical shape whose diameter gradually decreases from the tip 53 of the side surface portion 22 toward the opposite side of the bell cup main body 21 in the axial direction.

That is, at least a part (that is, the side surface portion 22) of the bell cup 200 is formed in parallel in the axial direction of the rotary drive shaft 12.

As in the side surface portion 22, the inclined side surface portion 202 is provided with at least one groove portion 203 on the inner surface 204. As in the first groove portion 41, the second groove portion 42, and the third groove portion 43 of the side surface portion 22, the groove portion 203 is formed in an annular shape to be recessed from the inner surface 204 of the inclined side surface portion 202 toward the direction of the outer surface 205. As in the first insertion hole 45 of the first groove portion 41, the second insertion hole 46 of the second groove portion 42, and the third insertion hole 47 of the third groove portion 43, the groove portion 203 has a plurality of insertion holes 206 as insertion holes provided in a zigzag arrangement.

Here, it is considered that the supply amount of the paint 5 (see FIG. 6(c)) supplied to the bell cup 200 increases and the paint 5 overflows from the third groove portion 43. In this case, the paint 5 overflowing from the third groove portion 43 can be made to flow toward the groove portion 203 of the inclined side surface portion 202 by the centrifugal force of the rotating bell cup 200 as shown by an arrow C and collected in the groove portion 203. Therefore, it is possible to secure the ejecting amount of the paint 5 ejected from the plurality of insertion holes 206 formed in the groove portion 203.

As a result, even when the supply amount of the paint 5 increases and the paint 5 overflows from the third groove portion 43, it is possible to prevent the paint 5 from leaking from the bell cup 200, other than the plurality of first insertion holes 45, the plurality of second insertion holes 46, the plurality of third insertion holes 47, and the plurality of the insertion hole 206. Therefore, the particle size of the paint 5 ejected from the side surface portion 201 (that is, the bell cup 200) can be stabilized, and stable painting quality can be obtained.

The technical scope of the present invention is not limited to the above-described embodiment, and various changes can be made without departing from the spirit of the present invention.

In addition, it is possible to replace the constituent elements in the embodiment with well-known constituent elements as appropriate without departing from the spirit of the present invention, and the above-mentioned modified examples may be appropriately combined.

What is claimed is:

1. A rotary atomization type painting apparatus in which a bell cup is attached to a rotary drive shaft of a painting apparatus,
wherein the bell cup has a side surface portion at least partially parallel to the rotary drive shaft,
a groove portion recessed toward a direction of an outer surface of the side surface portion is provided on an inner surface of the side surface portion, and
the groove portion is provided with an insertion hole configured to be inserted through the inner surface and the outer surface and eject a paint.

2. The rotary atomization type painting apparatus according to claim 1, wherein the groove portion is provided on the inner surface in an annular shape, and
a plurality of the groove portions are disposed on the side surface portion side by side in an axial direction of the rotary drive shaft.

3. The rotary atomization type painting apparatus according to claim 2, wherein the groove portion has a plurality of the insertion holes, and
in the plurality of insertion holes, the insertion holes adjacent to each other in the axial direction are disposed in zigzag.

4. The rotary atomization type painting apparatus according to claim 1, wherein a convex portion protruding from the inner surface toward the rotary drive shaft is provided in a tip region in the axial direction of the rotary drive shaft in the side surface portion, and
the convex portion is provided on the inner surface in an annular shape.

5. The rotary atomization type painting apparatus according to claim 1, wherein in the tip region of the side surface portion, a V-shaped notched portion extending in the axial direction of the rotary drive shaft is provided on an inner surface portion of the tip region in the inner surface, and
a plurality of the notched portions are provided on the inner surface portion in an annular shape.

6. The rotary atomization type painting apparatus according to claim 5, wherein in the tip region of the side surface portion, other V-shaped notched portion directed in a radial direction of the rotary drive shaft is provided at the tip in the axial direction of the rotary drive shaft, and
a plurality of the other notched portions are provided at the tip in an annular shape.
